(19) United States
(12) Patent Application Publication
(10) Pub. No.: US 2002/0124259 A1
(43) Pub. Date: Sep. 5, 2002

(54) Client-based interactive digital television architecture

(76) Inventors: Edward Y. Chang, Santa Barbara, CA (US); Raju Rangaswami, Goleta, CA (US)

Correspondence Address: GATES & COOPER LLP, HOWARD HUGHES CENTER, 6701 CENTER DRIVE WEST, SUITE 1050, LOS ANGELES, CA, 90045, US

(21) Appl. No.: 09/963,057

(22) Filed: Sep. 25, 2001

Related U.S. Application Data
(60) Provisional application No. 60/235,723, filed on Sep. 27, 2000.

(51) Int. Cl. H04N 7/173

(52) U.S. Cl. 725/91

(57) ABSTRACT

One or more embodiments of the invention provide a method, apparatus/system, and article of manufacture for supporting multiple interactive digital video streams. A first broadcast digital video stream is received. Thereafter, the received stream is stored into one or more I-files comprised of one or more intraframes (I-frames) and one or more PB-files comprised of one or more frames selected from a group comprising a predicted frame (P-frame) and a bidirectional predicted frame (B-frame). Such storage may be in accordance with a data placement policy (e.g., a round-robin policy, truncated binary tree policy, or truncated binary tree with data replication policy). The most appropriate scheme may also be selected based on various factors. Thereafter, first display digital video stream is provided that is based on the one or more I-files.

### CROSS REFERENCE TO RELATED APPLICATIONS

This application claims the benefit under 35 U.S.C. Section 119(e) of the following co-pending and commonly-assigned U.S. provisional patent application, which is incorporated by reference herein:

United States Provisional Patent Application Ser. No. 06/235,723, entitled “CLIENT-BASED INTERACTIVE DTV ARCHITECTURE”, filed on Sep. 27, 2000 by Edward Y. Chang et. al., Attorney Docket No. 30794.82USP1.

### BACKGROUND OF THE INVENTION

1. Field of the Invention.

The present invention relates generally to broadcast digital television, and in particular, to a method, apparatus, and article of manufacture for supporting multiple digital video streams.

2. Description of the Related Art.

The Federal Communications Commission (FCC) has mandated TV broadcasters to transmit TV in the digital format (referred to as digital television [DTV]) by the year 2006. The flexibility and extensibility of an all-digital system enable a wide range of interesting applications.

Both video on demand (VOD) and single user digital VCR devices have not generated much real interest. The reality of VOD is quite different from its hype. For example, while VOD trials are dribbling out in places like Cincinnati, Honolulu, Atlanta, and Los Angeles, only a small number of homes actually use the services. Meanwhile, personal VCRs have had limited acceptance because of their single user constraint and high cost.

One type of interesting application that may benefit and utilize an all-digital system is interactive DTV. Several schemes have been proposed for supporting interactive operations. These schemes can be divided into two approaches: (1) using separate fast scan streams, and (2) skipping frames in the regular stream. The first approach may not be used in the broadcast scenario since a program is broadcast at one single rate. The frame skipping approach can cause low 10 (input-output) resolution and consequently low system throughput.

In a prior art client-side approach, a client re-encodes frames during normal playback and saves them for replay. This approach can be CPU-intensive since most compression schemes ate encoding side heavy and hence may hinder a CPU from decoding more streams.

Many studies have proposed server-based interactive DTV architectures in which a server schedules its resources (e.g., memory and disk bandwidth) to service interactive VCR-like requests, such as pause, replay and fast-forward. In a server-based architecture, the clients are assumed to be passive, simply receiving bits and rendering frames. However, because of the typical long end-to-end transmission delay between a server and a client and the Internet's limited bandwidth, it is practically infeasible for the server to support “real-time” VCR-like interactive operations for tens of thousands of simultaneous users. Furthermore, on a broadcast channel (e.g., CNN), one simply cannot request the server to pause or to replay a program.

Accordingly, what is needed is an interactive DTV system that supports multiple users.

### SUMMARY OF THE INVENTION

One or more embodiments of the invention provide a method, apparatus, and article of manufacture for supporting multiple interactive digital video streams. A client-based architecture supports time-shift Digital-TV (DTV) features (i.e., pause, replay and fast-forward) and interactive applications.

To enable interactivity such as fast forward instant replay pause and slow motion for multiple users, data is organized effectively for improving IO resolution, reducing disk latency, and minimizing storage cost. Three data placement schemes are built on a simple real time memory management module. These schemes make different tradeoffs between IO resolution, disk latency, and cost to maximize system throughput under different resource constraints. Additionally, to assist selecting the right placement scheme in a given situation, selection guidelines and an admission control policy may be used to adapt to almost any performance objective

### BRIEF DESCRIPTION OF THE DRAWINGS

Referring now to the drawings in which like reference numbers represent corresponding parts throughout:

FIG. 1 depicts a personalizable DTV pipeline in accordance with one or more embodiments of the invention;

FIG. 2 shows four examples of representative delay functions in accordance with one or more embodiments of the invention;

FIG. 3 illustrates the use of memory pages in accordance with one or more embodiments of the invention

FIG. 4 shows a truncated binary tree formation for supporting three fast-scan speeds in accordance with one or more embodiments of the invention;

FIG. 5 presents an example that shows how I frames are distributed in accordance with one or more embodiments of the invention;

FIG. 6 compares the memory use of various data placement schemes in accordance with one or more embodiments of the invention;

FIGS. 7(a)-7(t) comprise various graphs that illustrate the relationship between the memory requirement and fast scan speedup for various data placement schemes and/or K values in accordance with one or more embodiments of the invention; and

FIG. 8 is a flow chart illustrating the support of multiple interactive digital video streams in accordance with one or more embodiments of the invention in accordance with one or more embodiments of the invention.

### DETAILED DESCRIPTION OF THE PREFERRED EMBODIMENTS

In the following description, reference is made to the accompanying drawings which form a part hereof, and which is shown, by way of illustration, several embodiments of the present invention. It is understood that other embodiments may be utilized and structural changes may be made without departing from the scope of the present invention.

Overview

One or more embodiments of the invention provide a novel system architecture that plays a client/server dual role to enable non interactive broadcast DTV streams into interactive ones for supporting multiple playback devices (e.g., in a library, in a classroom, or at home). Broadcast data is received and strategically placed to provide interactive capabilities. Three data placement schemes ate built on a simple real time memory management module. These schemes make different tradeoffs between IO resolution, disk latency, and cost to maximize system throughput under different resource constraints. Additionally, to assist selecting the tight placement scheme in a given situation, an admission control policy provides the ability to adapt to almost any performance objective.

Embodiments of the invention are based on a client-based interactive DTV architecture (referred to as Personalizable Interactive DTV). A receiver (a digital VCR or set top box) in this architecture is equipped with a large and inexpensive disk. A client can cache a large amount of media data received via a broadcast. This economical caching together with the random access capability of the disk enables a client to support time-shift operations. A viewer can pause a live DTV program to take a break from viewing while the broadcast stream continues arriving and being written to the local disk. The viewer can resume watching the program after the pause with a delay, or fastforward the program to get back in synch with the broadcast stream. The viewer can also record programs, filter out unwanted content, and produce a customized program which a tape-based VCR cannot do.

These time-shift functions allow one, for example, to do one's own instant replay during a sports program or to watch a remote lecture at one's own pace. One can also record programs at multiple channels at the same time (which a tape-based VCR cannot do), filter out unwanted content, and produce a customized program.

Adding an Internet back-channel in addition to the disk to a client (e.g., DTV box 106) allows media content to be customized in many ways without the client interacting with a server. While a given broadcast stream remains the same for all viewers, various data objects can be transmitted to individual viewers via the Internet channel. Data objects can be textual (e.g., a hypertext markup language page), binary (e.g., a Java™ applet), or continuous (e.g., a video/audio stream).

Image-based rendering techniques can overlay a number of data objects with the broadcast stream to provide a customized program. For instance, a viewer can query and change the attributes (e.g., color, shape, position and history) of these data objects or a broadcaster can target individual families with tailored advertisements via the back-channel.

With image-rendering techniques, the invention allows the viewer 110 to influence TV content at the frame level. For example, a virtual museum program may deliver data at very high rates but the DTV box 106 decodes, stitches, and displays only the frames that the user 110 views. In such an embodiment, children would be able to change the attributes (e.g., colors, size, position and even the personality) of a “bunny”, “big bird”, or other characters in a children's program. Similarly, a grade school student can learn American states by interacting with a map.

Adding an Internet back-channel in addition to a large disk to the DTV box 106 enables many more potential applications such as customized news, soaps, ads, and enhanced home-shopping channels. For example, self-paced distance learning may be enabled wherein a user 110 can view a lecture at one's own pace. Alternatively, a user 110 can replay a video or an audio segment of a live program to provide personalized instant replay. In another instance, a user 110 can create a personalized news program by recording news playing on multiple channels at the same time and composing a customized program of one's desire (e.g., skipping all financial news).

Managing heterogeneous DTV data objects (e.g., video, audio, texts, 3D graphics objects, etc.) at the client side to support interactive DTV features faces two major challenges: (1) different clients may have different available resources, and (2) different viewers may have different viewing preferences. A resource manager at the client side must allocate and schedule available resources adaptively to maximize each individual viewer's quality requirement.

Various techniques of the invention may be used to manage DTV data objects under the constraints of the local resources to maximize the client's quality of service (QoS). A viewer can assign a QoS factor to a data object to convey that object's scheduling priority to a resource manager. The resource manager then schedules the local resources for the data objects in an order that maximizes the total QoS. The invention provides a client-based architecture that can support interactive DTV features effectively with very low memory requirements and hence at a low cost.

In addition, one or more embodiments of the invention support multiple interactive streams on one receiver (i.e., one setup box or one digital VCR). With the multi stream capability, students in a virtual classroom or at a library can watch a live lecture at their own pace via one shared receiver. A family can use one receiver as the stream server at home to support interactivity at multiple playback devices. This architecture gives a receiver a client/server dual role. On the one hand, the receiver acts as a client for broadcasters or servers to enable interactivity. On the other hand, the receiver caches streams for servicing a number of end devices to amortize cost.

Designing a client/server dual system to support interactivity however, is a non-trivial task. On the one hand, the receiver must write broadcast signals to its disk to minimize memory use for staging streams. On the other hand, the receiver must read data from the disk into main memory before the decoder runs out of data. In addition, when simnultaneous fast scans (i.e., fast forward and replay) are requested, the reads can happen at very high rates. The system must ensure that all IOs can be done not only on time to meet their deadlines but also at the minimum cost.

Accordingly, in designing an appropriate receiver, at least three design parameters should be kept in mind: IO resolution, disk latency, and storage cost (both memory and disk cost). Since the improvement on one performance factor can often lead to the degradation of the others, tradeoffs between these design parameters must be considered and made carefully. Memory management and data placement policies of the invention provide support for multiple simultaneous interactive streams.

A simple memory management scheme that is efficient and easy to implement may be used. On top of this memory management scheme, three data placement policies are utilized. Additionally, to assist selecting the right placement scheme to employ in a given situation, selection guidelines and an admission control policy may be used to adapt to select the appropriate placement scheme to accomplish almost any performance objective.

Hardware Environment

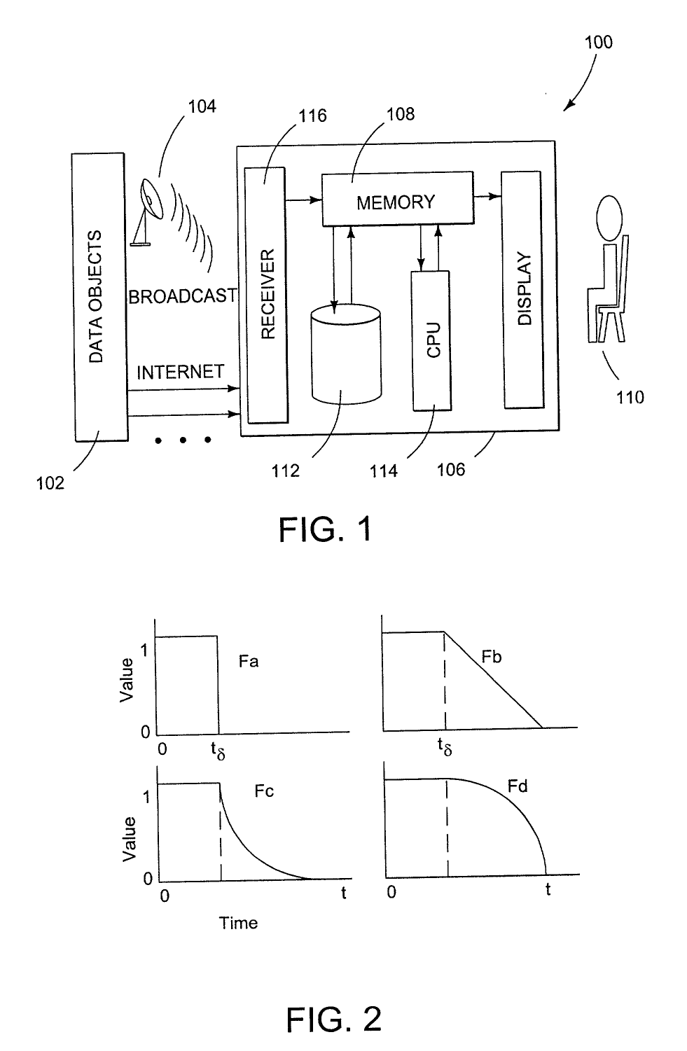

FIG. 1 depicts a personalizable DTV pipeline 100. On the left-hand side of the pipeline 100, data objects 102 are transmitted via broadcast 104 and point-to-point channels to a DTV box 106. The DTV box 106 receives network packets in its main memory 108. If the data 102 is not needed shortly (e.g., the viewer 110 paused the playback), the data 102 is written to the box's 106 local disk 112 to conserve memory. The data 102 is made available to the CPU 114 before it is needed. The CPU 114 processes (e.g., computes, decodes, renders, etc.) the data 102 in main memory 108, and finally the processed data 102 is played back to the viewer 110 on the right-hand side of the pipeline 100.

A DTV pipeline 100 consists of two major components: DTV data objects 102, and system resources, including CPU 114, memory 108, and a local disk 112.

Data objects 102 can be continuous, textual, binary, and so forth. The objects 102 are best characterized by their sizes and latency constraints. Continuous data 102 may comprise audio/video streams, which can be voluminous (video streams) and delay sensitive. Textual data may include captions, HTML and XML documents, etc. Textual data in general occupy far less space than continuous data and are not delay sensitive. Other data objects 102, such as images and applets, can be very copious or scant and may or may not be delay sensitive, depending on the nature of the application.

The size of a data object is measured by the amount of storage space it needs and is denoted by S₁, where i stands for the i^{th} object. To quantify the delay sensitivity of a data object 102, one can specify a value function for it. The function can be defined in many ways. FIG. 2 shows four examples of representative delay functions. The x-axis in FIG. 2 depicts delay, while the y-axis depicts the value of the object normalized to from zero (worthless) to one.

Function Fₐ depicts an object that can tolerate delay up to a period of time, t_{δ}, after which the object becomes worthless. Function F_{b} shows the value of an object that decays linearly after t_{δ}. Functions F_{c} and F_{d} have other value decay patterns. Function Fₐ is a good value function for an audio frame. Function F_{b} may be a good value function for a video frame since slight delay of a frame display may be tolerable. Function F_{b} may be a good value function for a subtitle. Function F_{d}, which shows that a user's patience decays exponentially after t_{δ}, may be a good value function for a Web page. Without losing generality, the value function for object i is defined as fᵢ(t), where t denotes the span between the time the object is requested and the time the object is available in main memory for processing.

In short, data objects may be characterized with Sᵢ representing the i^{th} object's storage requirement, and fᵢ(t) depicting the i^{th} object's delay sensitivity.

As described above, the other major component (besides data objects 102) are system resources. The system resources likely include a CPU 114, memory 108, and a local disk 112. Local disk 112 may be a large inexpensive disk that enables a DTV box 106 to cache a large amount of media data (e.g., data objects 102).

Scheduling Resources

A resource manager at the client side must allocate and schedule available resources adaptively to maximize each individual viewer's quality requirement. As described above, the local resources include CPU 114, memory 108, disk bandwidth and network bandwidth. The local resources may not be adequate to support a particular interactive scenario. Therefore, it is critical for the resource manager to be adaptive to the resource constraints and to degrade, if degradation is unavoidable, in a graceful manner. Given limited resources, the design objective of a DTV box 106 is to prioritize resource allocation in order to maximize the user's 110 satisfaction.

To measure a user's 110 satisfaction, the user may provide information regarding what is important and what is not. Accordingly, each data object 102 may be associated with a QoS parameter to convey that object's 102 scheduling priority to the resource manager. The viewer 110 can assign a QoS value to each data object 102, either implicitly or explicitly. For instance, if a user 110 decides to turn off all interactive features, the resource manager can assign a QoS factor of zero to data objects 102 that are needed to support interactive features. With respect to the data objects 102 that are needed to support the playback, higher QoS can be assigned to mission-critical data objects, such as broadcast video and audio streams, and lower QoS can be assigned to optional data objects such as captions and applets.

The resource manager then schedules the local resources for the data objects 102 in an order that maximizes the total QoS. Thus, given Nₐₗₗ requested data objects and M available memory, the goal of the resource manager is to schedule N data objects (N≦Nₐₗₗ) to maximize the total QoS under the resource constraints. αᵢ denotes the QoS requirement assigned to the i^{th} data object 102 (0≦αᵢ≦1) and τᵢ denotes the latency needed to stage the i^{th} data object 102 in main memory. The value of τᵢ depends on the local disk 112 bandwidth and network bandwidth, and the size of the data object 102. Further, suppose j represents the scheduling order for N data objects 102. The objective function for scheduling the service to these N data objects in the order that maximizes the sum of the QoS can be written as:

$$Max {\sum }_{j = 1}^{N} {α}_{j} \times {f}_{j} ( t - {\sum }_{k = 1}^{j} {τ}_{k} )$$

Which is subject to the memory constraint

$${\sum }_{j = 1}^{N} {S}_{j} \leq M .$$

Supporting Regular Playback, Pause, and Slow Motion

Referring again to FIG. 1, to support interactive operations, a receiver 116 in a DTV box 106 may need a huge amount of buffer. For instance, pausing a 6.4-Mbps DTV stream for thirty minutes requires 1.44 GBytes of cushion. Pausing a 19.2-Mbps HDTV stream for the same duration requires 4.32 GBytes of buffer. One or more embodiments of the invention manage the receiver's 116 local resources efficiently so that the DRAM requirement can be drastically reduced. A memory 108 allocation scheme as described herein provides support for regular playback and pause.

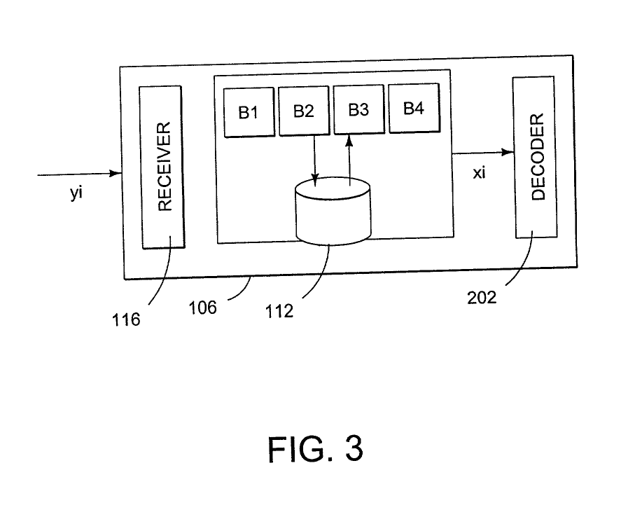

Referring now to FIG. 3, for the regular playback of a continuous data stream, a resource manager allocates four memory pages (B1-B4) of equal size. These four pages are ping-ponged between the receiver 116 and the decoder 202 and are used to receive incoming data from the network, write data to the disk 112, read data from the disk 112, and provide data for decoding. The receiver 116 and the decoder 202 may each own at most two pages at any time (even during a pause or a slow motion operation). The following example illustrates how the resource manager manages these four pages for a video playback.

At the start of the video playback the resource manager allocates four pages denoted by B1, B2, B3, and B4, for a stream. Once data arrives, the resource manager receives the data in one of the pages, (e.g., Bl). When B1 is full, B1 is available for decoding and hence the resource manager hands B1 to the decoder 202. In this example, assume the playback starts once B1 is filled up and is assigned to the decoder 202. The playback can start earlier or later depending on the difference between the data delivery and playback rates.

For example, if the data delivery rate is substantially lower than the playback rate the resource manager must accumulate enough data on disk 112 before the playback can start to prevent display hiccups. At the same time, the resource manager assigns another memory page say B2, to the receiver 116 to continue receiving data. When page B2 is full, the resource manager hands B2 to the decoder 202 and assigns B3 to the receiver 116 to continue receiving data. At this time, the decoder 202 owns pages B1 and B2 and the receiver 116 owns B3.

One of two events occurs next: either the data in page B1 is used up by the decoder 202 or page B3 is filled up by the incoming packets. The resource manager takes different actions according to which event occurs first.

If B1 is used up first, the resource manager simply returns the page to the free pool. However, if B3 is filled up first, the resource manager writes the page to the disk 112. Note that the decoder 202 does not need B3 immediately. The decoder 202 only needs B2 to safeguard a hiccup free playback. When B3 is being written to the disk 112, B1 and B2 are held by the decoder 202. The resource manager must use page B4 to receive incoming data. B4 must be large enough for the resource manager to complete writing B3 to disk 112, or the receiver 116 runs out of memory space to receive data once B4 is full.

At this time, one of two things can happen next: the data in page B1 is used up by the decoder 202 or page B4 is filled up by the arriving data.

When B1 has been consumed by the decoder 202, the decoder 202 starts consuming B2. At the same time, the resource manager has to make sure that the data after that in B2 is made available to the decoder 202 before the decoder 202 uses up B2, or hiccups occur. If the decoder 202 uses up B1 before B3 is full, the resource manager assigns B3 to the decoder 202 as soon as the page is filled up. If B3 is filled up before page B1 is consumed, an IO to write B3 to the disk 112 may be in progress or may have been completed. In the former case, the resource manager still makes B3 available to the decoder 202 by ignoring the write (canceling the write may not be possible). If the write has been completed, the resource manager reads the data back from the disk 112 into B1 (the decoder 202 uses the data in B1 after B2 is consumed). Note that the size of page B2 must be large enough to allow enough time for page B1 to be replenished.

If page B4 is filled up first, the resource manager writes the data to the local disk 112. Since either page B1 or B3 must have been free at this time, the resource manager uses the available page as the receiving buffer.

In summary, the resource manager is driven by two events: page consumed, when the decoder 202 has consumed a page, and page full, when the receiver 116 has filled up a page. When the page consumed event occurs, the resource manager may need to read a page of data from the disk 112 before the decoder 202 uses up the next page. The page thus must be large enough to provide data to the decoder 202 before the read is completed. When the page full event occurs, the resource manager may need to write the page to the disk 112 to free up space for use. The page must be large enough so that during the write, the receiver 116 cannot fill up another page. This four-page ping pong scheme enjoys various benefits.

One benefit is that when a pause is issued (the page consumed event is halted), the receiver 116 uses the local disk 112 as the cushion. Using the local disk 112 extends the buffering capacity drastically at the minimum cost. The main memory requirement is limited to only four pages at all times. A second benefit is that the scheme can support slow motion without dropping any arriving bits or causing overflow of the decoder 202 buffer. Additionally, the scheme does not perform unnecessary memory-to-memory or memory-to-disk 112 copy if the data is played back in real time.

Supporting Fast Scans

The four-buffer ping-pong scheme described above may be extended to support fast-scan operations. A fast-scan plays back a media stream at Id times its encoding rate in either a forward direction (fast forward) or a backward direction (replay).

As described herein, fast scans are discussed in the context of MPEG2 (Motion Pictures Expert Group 2) formatted streams. However, multiple different types of encoding schemes may be used in accordance with this invention and the scope of the invention is not intended to be limited to the MPEG2 format. With the MPEG2 format, a data stream/sequence is encoded using three different types of frames: intraframes (I frames), predictive frames (P frames), and Bidirectional predictive frames (B frames).

I frames contain data to construct a whole picture as they are composed of information from only one frame.

P frames contain only predictive information (not a whole picture) generated by looking at the difference between the present frame and the previous one. P frames contain much less data than the I frames and so help towards low data rates that can be achieved with a MPEG signal.

B frames are composed by assessing the difference between the previous and the next frames in a television picture sequence (wherein such reference frames are either I frames or P frames). As B frames contain only predictive information, they do not make up a complete picture as so have the advantage of taking up much less data than the I frames. However, to see the original picture requires a whole sequence MPEG 2 frames to be decoded (including I frames and possibly P frames).

To support a K-times speedup fast-scan the receiver 116 displays one out of every K frames. To allow K to be any positive integer, however, the receiver 116 can suffer from high IO memory and CPU 114 overhead. This is because a frame that is to be displayed (e.g., a B frame) may depend on some frames that are to be skipped (e.g., an I and a P frame). The receiver 116 may have to end up reading staging in main memory and decoding much more frames than it displays. Accordingly, by using appropriate data placement schemes, poor IO resolution may be remedied.

Without loss of generality, a video can be assumed to consist of m frame sequences, wherein each sequence has δ frames on an average, and is led by an I frame and followed by a number of P and B frames. To avoid processing the frames that are to be skipped, B frames are not involved in a fast-scan and a P frame is only played back if the P frame's dependent I frame is also involved in the fast scan. Such a restriction may not allow a user to request a fast-scan of every speedup. However, supporting a few (e.g., five) selected speeds of fast-scans may be adequate since a VCR or DVD player supports three to five fast-scan speeds.

To improve IO resolution, frames that are not involved in a fast-scan are not read in. Upon initial examination, it may appear that a stream can be placed sequentially on disk 112 and just those selected frames may be read from the file stored thereon. This naive approach however does not save read time since the disk 112 arm still has to pass the skipped frames (e.g., B frames) on the track on its way to the selected frames (e.g., I frames). In addition, most modem disks 112 read the entire track into disk 112 cache before transferring the selected frames. As a consequence, the throughput of the disk degrades severely.

To improve IO resolution, three κ-file data placement schemes may be used. Each scheme separates a video into two groups: an I-frame group and a P and B frame group. The schemes distribute I frames into I-files and stores P and B frames in a PB-file. When a δ×n (n is a positive integer) times speedup fast-scan is requested, the receiver 116 needs to read one or more I-files only. However, separating frames into more than one file incurs additional IO overhead for writes. This is because rather than performing one sequential IO to write out a data block, multiple writes must be performed for each file thereby increasing the number of seeks.

Accordingly, one or more embodiments of the invention provide a carefully designed system that manages the tradeoffs between design goals such as improving IO resolution, reducing disk latency, and minimizing storage (memory and disk 112) cost.

The three schemes described herein are the file Round Robin (RR) scheme, the file Truncated Binary Tree (TBT) scheme, and the file Truncated Binary Tree with Replication (TBTR) scheme. Each of the schemes has distinct advantages and disadvantages.

For example, while the Round Robin scheme enjoys lower disk cost, it may suffer in terms of disk latency. Comparatively, the TBT scheme may enjoy good IO resolution, but at the cost of disk latency. Further, the TBT scheme with replication may provide good IO resolution and lower disk latency, but at the expense of disk 112 cost. Table 1 summarizes the pros with positive signs and cons with negative signs of these data placement schemes with respect to IO resolution, disk latency, and disk cost. These pros and cons will become evident as the schemes are described in greater detail below.

TABLE 1

| Scheme | IO Resolution | Disk Latency | Disk Cost |
|---|---|---|---|
| Sequential File | − | + | + |
| Round Robin | + | − | + |
| TBT | ++ | − | + |
| TBT with Replication | ++ | + | − |

Scheme Summary (+ is an advantage and − is a disadvantage

κ-File Round-Robinn (RR)

The round-robin (RR) scheme is a simple method to improve IO resolution. Let the I-Frames be numbered as I₁, I₂, I₃. . . Iₘ. The RR placement scheme stores P and B frames in a separate file and distributes I frames among κI-files, F₁, F₂, . . . F_{κ}, in the following round robin manner:

$${F}_{i} = \{ {I}_{i + n \times κ} \vert n = 1 , 2 , 3 ⋯ \frac{m}{κ} \}$$

For example, with κ=3, there are three I-files, F1, F2 and F3, consisting of the following frames F1={I₁, I₄, I₇, I₁₀, . . . }, F2={I₂, I₅s, I₈, I₁₁, . . . }, and F3={I₃, I₆, I₉, I₁₂, . . . }.

How this scheme works depends on the requested speedup (κ) of the fast-scan. Suppose δ=9 and κ=3. A K=27-times speedup fast-scan reads frames from only one I-file for playback. A faster fast-scan (e.g., K=54 or 81) requires reading only one I-file, but at a faster pace by skipping some I frames, which leads to low IO resolution. The value of κ may be increased to improve IO resolution. However, increasing κ increases disk latency for preparing I-files and for supporting lower speedup fastscans. To maintain good IO resolution without aggravating disk latency, the following κ-File TBT scheme may be utilized.

κ-File Truncated Binary Tree (TBT)

In the Truncated Binary Tree (TBT) approach, good IO resolution may be provided at all fast-scan speeds while maintaining low disk latency at the same time. To provide good IO resolution, I frames are organized into a tree structure so that only wanted frames are read. To control seek overhead, two control parameters, α and β, may be utilized (see description below).

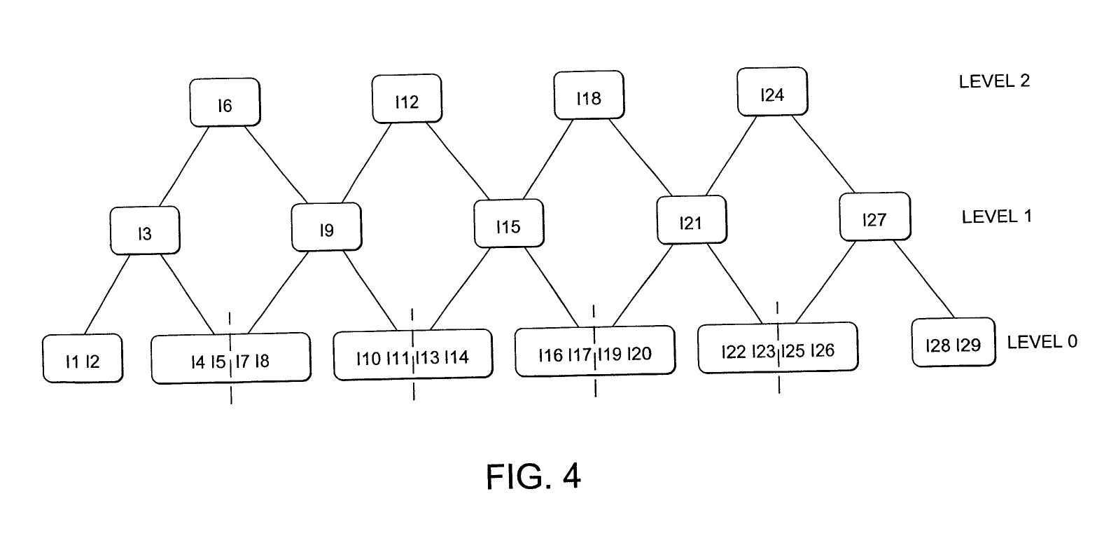

An example TBT tree is presented in FIG. 4 which shows a truncated binary tree formation for supporting three fast-scan speeds: δ-speedup, 3δ-speedup and 6δ-speedup. A normal playback requires retrieval of frames from the tree by performing an in-order traversal. For fast-scans, different tree levels are retrieved depending on the requested speed. The higher the speed, the higher the tree-levels the fast scan operation reads. For example a 3δ-times speedup fast-scan accesses the I frames at levels one and two in the tree and a 6δ-times fast-scan reads I frames at level two only.

Formally, the TBT scheme distributes I frames among κ I-files, F1, F2. . . F κ, in the following manner:

F₁={I_{κ}|1≦κ≦m∩I_{κ}∉{F₂∪F₃∪F₄. . . ∪F_{κ}}} such that

Fᵢ={I_{n×α×β}_{ⁱ⁻¹}|n∈{1,2,3, . . . }∩I_{n×α×β}_{ⁱ⁻¹}∉{Fᵢ₊₁∪Fᵢ₊₂∪Fᵢ₊₃. . . ∪F_{κ}}}, for 2≦i≦κ

Here α is the Frame Span factor and β is the Scan Speed Resolution factor. Parameter α determines the number of I frames bunched together in the lowest level of the tree. Parameter β determines the number of I frames to be read at the same level (or file) before being required to read from a file at a higher level in the tree. The values of α, β, and δ determine the fast-scan speeds that the system can support. For example, if we let δ=9, α=3 and and β=3, then the speedups available are 3, 9, 27, 81, etc. If β is increased from three to four, then the accessible speedups become 3, 9, 36, 144, etc.

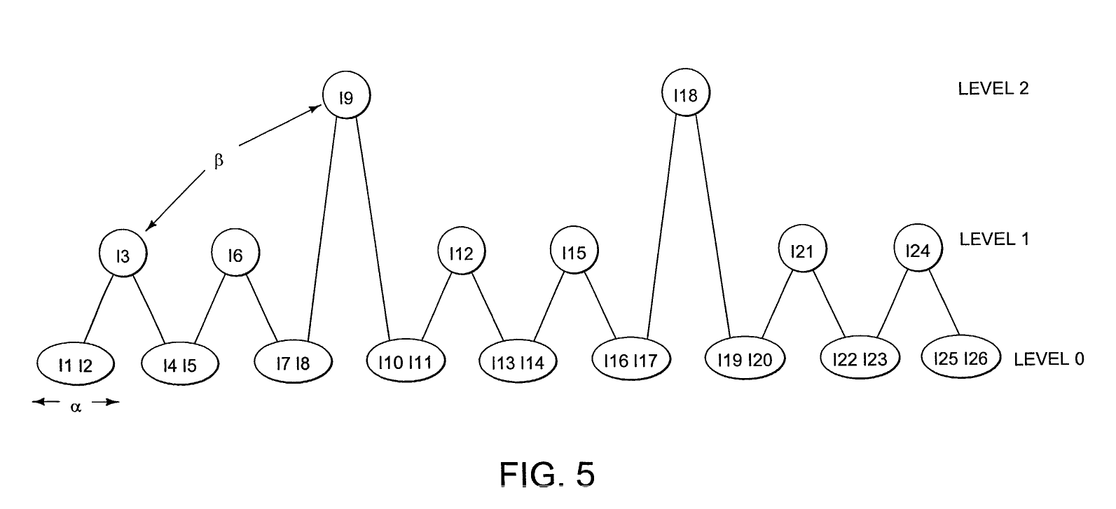

FIG. 5 presents an example that shows how I frames are distributed when κ=3, α=3 and and β=3. In FIG. 5, three I-files contain the following frames:

F1={I1, I2, I4, I5, . . . I7, I8, . . . }

F2={I3, I6, I12, I15, I21, . . . }

F3={I9, I18, I36, I45, . . . }

Truncated-Binary-Tree with data Replication (TBTR)

Although the TBT scheme enjoys improved IO resolution, its disk 112 latency can be high due to the need to read data from mote than one file. The TBTR scheme trades disk storage to reduce disk latency. Again, to achieve good IO resolution, the same I frame distribution method as the TBT scheme is used. In addition, I frames are replicated at higher levels of the tree in all files at lower levels. The I frames in the I-files are thus changed as follows:

Fᵢ={I_{κ}|1≦κ≦m} such that

Fᵢ{I_{n×α×β}_{ⁱ⁻¹}|n∈{1,2,3, . . . }}, for 2≦i≦κ

Table 2 illustrates the parameters used in the above equations for the TBTR

TABLE 2
Parameter Description
Equation Parameters

| | |
|---|---|
| N | Number of simultaneous streams |
| T | Total 10 time cycle |
| Tr | Time taken to read from disk for a single stream in Time T |
| Tw | Time taken to write broadcast data for single stream in time T |
| TR | Minimum disk data transfer rate |
| γ(d) | Worst case latency to seek d tracks |
| DR | Display rate of MPEG stream |
| B | Buffer size to support a single stream |
| Memmin | Minimum memory required to support N streams |
| SI | Average size of an I frame |
| κ | Number of I-files |
| IT | Average number of I-Frames in buffer B |
| K | Speed of fast scan requested |
| Kmax | Maximum Speed of fast scan supported |
| α | Frame Span factor |
| β | Scan Speed Resolution factor |
| φ | Size of I frame over average frame size |
| δ | Number of frames separating 2 I Frames in the MPEG stream |

For example with κ=3, α=8, and β=2, three I-files contain the following I frames:

F1={I1, I2, I4. . . }

F2={I8, I16, I24, I32. . . }

F3={I16, I32, I48, I64, . . . }

The advantage of the TBTR scheme is that one sequential file supports each fast-scan speed. Therefore, 100% IO resolution with minimum disk latency at the same time may be achieved. During normal playback, for instance, only file F1 (plus the PB-file) may be read. During fast-scans, only one I-file may be read. For example, for a 16δ-speedup fast scan, only file F2 may be read. Improving IO resolution reduces memory use. But teplicating data on disk 112 increases disk 112 storage cost and increases data transfer overhead to replicate data in multiple I-files.

Quantitative Analysis

In order to understand how the design parameters, IO resolution, disk latency, and storage cost interplay with one another, the resource requirement for each of the schemes is formulated as described below.

Suppose the system serves N simultaneous streams with T denoting the cycle time for completing a round of IOs for servicing N streams. In time cycle T, the system executes the following procedures simultaneously:

1. Each stream is served by a Receiving Thread that takes care of reading in broadcast data for the stream and storing it in the Receiving Buffer for that stream. The Receiving Buffer is large enough to hold all incoming data for IO time cycle T. When the buffer gets filled, this thread triggers a write IO to free the buffer for more incoming data.

2. At the same time, an IO scheduler thread chooses a stream to serve and schedules a read IO for reading into the Display Buffer. Read IO may or may not be required depending on whether the playback stream is delayed in time or not. The read IO also depends on user interaction. If the user has paused and the Display Buffer already has data for time cycle T, then no IO is required. The worst case (i.e., requiring read IO) for all calculations is assumed. The Display Buffer again, has to be large enough to support playback for time T. The read IO can serve a fast-scan or a normal playback depending on user interaction. If a fast-scan request is issued by the user, then only the I-Files need to be read from, else the PB-File also needs to be read. This process is repeated for each of the N streams.

3. Each stream also has a Display thread that displays MPEG data stored in the Display Buffer to the viewer.

The unit time cycle may repeated over and over again. Even though this model may be event driven, there exists a basic time cycle in which all IO operations for N streams are served. To analyze the receiver's 116 use of main memory, the invention attempts to avoid as much as possible, display hiccups due to variability and delays in the input stream. Studies have shown that even just losing 0.1% of data may cause significant degradation in display quality resulting from inter-frame decoding dependencies. Therefore, taking a conservative approach, the worst case disk latency is assumed as well as peak data consumption and input rates.

An IO cycle T consists of writes and reads. Suppose each file is stored physically contiguous on disk 112. First, the worst case write time and the worst case read time are modeled and then combined to compute the IO cycle time for both placement schemes. The parameters used in deriving equations are illustrated in Table 2 above.

κ-File Round-Robin

The κ-File Round-Robin placement scheme needs to write the arriving video to κI-files and one PB-file. The size of the buffer required to sustain playback for time T can be written as B=T×DR. The number of seeks for writing is κ+1, and the data transfer time is capped by

$$\frac{B}{TR} .$$

The worst case IO write time denoted as T_{w} can be written as:

$${T}_{w} = ( κ + 1 ) γ ( d ) + \frac{B}{TR}$$

Where γ(d) computes the average disk latency for seeking d tracks, B denotes the page size, and TR denotes the disk transfer rate.

Next, the worst-case read time is modeled. Suppose the average size of an I frame is Φ-times the size of an average frame. The worst-case read time are analyzed in the following four cases:

1. K≦δ: This captures normal playback and slower fast scan modes wherein all frames read need to be played back. In this case, all I-files and the PB-file are read. The seek overhead is (κ+1)×γ(d) and the data transfer time is

$$\frac{ϕ \times B}{TR}$$

Since it may be assumed that each frame is replaced by an I frame and thus the IO size is Φ-times the average page size B.

2. K=κ×δ: All frames from a single I-file must be read to achieve a fast scan speed of κ×δ. The seek overhead is thus γ(d) and the data transfer time is capped by

$$\frac{ϕ \times B}{TR} .$$

3. K=n×κ×δ: Read only one I-file but skip every n-1 out of n frames. The seek overhead is γ(d) and the data transfer time is

$$\frac{K \times ϕ \times B}{κ \times δ \times TR} .$$

Notice that the

$$\frac{K}{κ \times δ}$$

factor in front of

$$\frac{ϕ \times B}{TR}$$

represents the IO resolution. For instance, if Kₘₐₓ=81, κ=3, and δ=9, only one out of every three I frames in one I-file are displayed and hence needs to transfer data three times faster.

4. Other K values: Other K values may not be supported since that can cause much higher DRAM requirement.

The worst-case read time for the Ks that may be supported happens in either the first or the third case, or

$${T}_{r} = max \{ ( κ + 1 ) γ ( ⅆ ) + \frac{ϕ \times B}{TR} , γ ( ⅆ ) + \frac{κ \times ϕ \times B}{κ \times δ \times TR} \} .$$

Let T be the IO cycle time to input pages for the decoder 202 and to write out the incoming pages before the receiving buffer overflows. To support N simultaneous users, T may be written as T=N×(Tᵣ+T_{w}).

The size of the regular playback buffer B must be large enough to sustain T time playback which can be expressed as B≦DR×T, where DR is the peak display rate. To conserve memory, equality may be taken, resulting in B=DR×T.

Based on the above equations B can be solved and expressed as:

$$B = max \{ \frac{2 \times ( κ + 1 ) \times γ ( ⅆ ) \times N \times TR \times DR}{TR - ( 1 + ϕ ) \times N \times DR} , \frac{( κ + 2 ) \times γ ( ⅆ ) \times N \times TR \times DR}{TR - N \times ( 1 + \frac{K \times ϕ}{κ \times δ} ) ) \times DR}$$

After obtaining B, the memory requirement to support an up to Kₘₐₓ times speedup fast-scan for N users is Memₘᵢₙ=4×N×B.

κ-File Truncated-Binary-Tree

The Truncated-Binary-Tree scheme is analyzed first without data replication and then with replication. The Truncated-Binary-Tree scheme differs from the Round-Robin scheme mainly because of better IO resolution. The incoming data stream is written into at most κI-files and a PB-file. First, analysis common to both schemes is presented. The size of the buffer required to sustain playback for time T can be written as B=T×DR. The number of I frames in buffer of size B is given by

$${I}_{T} = \frac{T \times DR}{ϕ \times {S}_{I}} .$$

The number of seeks for writing is given by exp where exp is the minimum integer such that

$$\frac{{I}_{T}}{α \times {β}^{exp}} \leq 1.$$

Out of these seeks, (exp−1) are seeks to I-files and 1 seek is for the PB-file. For example, let α=β=3. Assume that the display begins from the first I frame I1 and that all I frames need to be read into the buffer. Accordingly, the number of I frames to be read is determined by

$${I}_{T} = \frac{T \times DR}{ϕ \times {S}_{I}} .$$

Based on the distribution of I frames as described above, the last I frame that needs to be read is given by I_{α×β}_{^{exp-1}}, where exp is the minimum integer such that

$$\frac{{I}_{T}}{α \times {β}^{exp}} \leq 1.$$

Accordingly, the number of I-files to be read from is given by exp−1.

In the worst case, even if the current display pointer is placed in an unfavourable position, the same number of seeks may still be achieved by dropping a single frame. By dropping a single frame, the memory requirement may be reduced considerably, without causing any noticeable degradation in quality. Further, to conserve memory it may be assumed that

$$exp = {log}_{β} \frac{{I}_{T}}{α} .$$

The time for data transfer is given by

$$\frac{B}{TR} .$$

The worst-case IO write time, denoted as T_{w} can be written as:

$${T}_{w} = exp \times γ ( d ) + \frac{B}{TR}$$

Next, the worst-case read time may be modeled. The worst-case read time may be modeled in the following four cases:

1. K<δ: This captures normal playback and slower fast scan modes. In this case, all I-files and the PB-file may need to be read. Hence the number of seeks for reading is given by exp. If it is assumed that each frame is replaced by either an I frame of a P Frame, the seek delay is exp×γ(d) and the data transfer time is capped by

$$\frac{\frac{ϕ}{2} \times B}{TR} .$$

2. K=δor K=α×βⁱ⁻¹×δ: This is the fast scan mode. Some of the I-Files may need to be read from. In this case, the buffer B has to be filled with only I Frames but more data may need to be read to maintain the same display rate. Hence, the number of I Frames in buffer B is given by

$${I}_{TF} = \frac{ϕ \times T \times DR}{{S}_{I}}$$

And, the number of seeks for reading is given by expf, where expf is the minimum integer such that

$$\frac{{I}_{TF}}{α \times {β}^{{exp}_{F}}} \leq 1.$$

To conserve memory, it is assumed that equality holds in the above equation. Hence,

$${exp}_{F} = {log}_{β} \frac{{I}_{TF}}{α} .$$

Thus, the seek delay is exp_{f}×γ(d) and the data transfer time is capped by

$$\frac{ϕ \times B}{TR} .$$

3. Other K values: Other K values may not be supported since such support may cause much higher DRAM requirements.

The worst-case read time for the Ks that may be supported happens in the second case. Hence,

$${T}_{r} = {log}_{β} ( \frac{ϕ \times T \times DR}{{S}_{I} \times α} ) \times γ ( d ) + \frac{ϕ \times B}{TR} .$$

Let T be the IO cycle time to input pages for the decoder and to write out the incoming pages before the receiving buffer overflows. To support N simultaneous users, T may be written as T=N×(Tᵣ+T_{w}).

The size of the regular playback buffer B must be large enough to sustain T time playback, which can be expressed as B≧DR×T, where DR is the peak display rate. To conserve memory, equality may be taken, which provides B=DR×T.

Based on the equations for T_{W}, Tᵣ, T, and B described above, the equation for B may be reduced to:

$$( \frac{TR - ( ϕ + 1 ) \times N \times DR}{2 \times γ ( d ) \times N \times TR \times DR} ) \times B = {log}_{β} ( \frac{B}{α \times {S}_{I}} )$$

After B has been obtained, the memory requirement to support an up to Kₘₐₓ times speedup fast-scan for N users can be obtain by Memₘᵢₙ=4×N×B.

Truncated-Binary-Tree with data Replication

The time for writing arriving data to disk is modeled first. The number of seeks is the same as with the κ-file truncated binary tree discussed above and the fine for data transfer is given by

$$\frac{( 1 + \frac{1}{ϕ} ) \times B}{TR} .$$

The factor of

$$\frac{1}{ϕ}$$

is an upper bound on the data replication overhead. More data needs to be written out due to replication. The worst-case IO write time, denoted as T_{w} can be written as:

$${T}_{w} = exp \times γ ( d ) + \frac{( 1 + \frac{1}{ϕ} ) \times B}{TR}$$

Next, the worst-case read time is modeled. The worst-case read time is analyzed in the following four cases:

1. K<δ: This captures normal playback and slower fast-scan modes. Due to replication, all I frames of the stream are present in file F1. Hence, the number of seeks for reading is 2, one for seeking file F1 and the other for seeking the PB file. The seek delay is thus 2×γ(d) and data transfer time is

$$\frac{\frac{ϕ}{2} \times B}{TR} .$$

2. K=δor K=α×βⁱ⁻¹×δ: This is the fast scan mode only the I-file Fi needs to be read from. Hence, the seek delay is γ(d) and the data transfer time is capped by

$$\frac{ϕ \times B}{TR} .$$

3. Other K values: Other K values may not be supported since that may cause much higher DRAM requirements.

The worst case read time for the Ks that may be supported happens in the first case or the second case. However, it may be noted that the extra seek during normal playback is overshadowed by the larger amount of data transfer involved in the fast scan operation. Hence,

$${T}_{r} = γ ( d ) + \frac{ϕ \times B}{TR} .$$

Let T be the IO cycle time to input pages for the decoder and to write out the incoming pages before the receiving buffer overflows. To support N simultaneous users, T may be written as: T=N×(Tᵣ+T_{w}).

The size of the regular playback buffer B must be large enough to sustain T time playback which can be expressed as B≧DR×T, where DR is the peak display rate. To conserve memory, equality may be taken resulting in B=DR×T.

Based on the above equations for T_{w}, Tᵣ, T, and B, the equation for B may assume the form:

$$( \frac{TR - ( 1 + ϕ + \frac{1}{ϕ} ) \times N \times DR}{γ ( d ) \times N \times TR \times DR} ) \times B = {log}_{β} ( \frac{β \times B}{ϕ \times α \times {S}_{I}} )$$

After B has been obtained, the memory requirement to support an up to Kₘₐₓ times speedup fast-scan for N users can be obtained by Memₘᵢₙ=4×N×B.

Performance Evaluation

Three factors may affect the performance of fast scans: 1) IO resolution, 2) disk latency, and 3) storage cost. The description below evaluates the performance of the data placement schemes of the invention. Since equations have been developed for computing memory use and overall cost, the parameters in the equations may be replaced with the parameters of a modern disk for use in the evaluation. The evaluation is intended to answer the following questions:

How do the data placement schemes perform against a scheme that simply stores a video sequentially on disk? How does minimizing IO resolution affect disk latency? Can data replication reduce sufficient memory cost to make it effective? How should an admission control policy work to degrade the system performance in a graceful manner when the disk bandwidth or memory capacity cannot support N simultaneous fast scans?

Table 3 lists the parameters for a sample disk used to study and compare the data placement schemes.

TABLE 3

| Parameter Name | Value | |
|---|---|---|
| Disk Capacity | 26 | Gbytes |
| Number of cylinders, CYL | 50,298 | |
| Min. Transfer Rate TR | 130 | Mbps |
| Rotational Speed (RPM) | 5,400 | |
| Full Rotational Latency Time | 11.2 | ms |
| Mm. Seek Time | 2.0 | ms |
| Average Seek Time | 8.9 | ms |
| Max. Seek Time | 18 | ms |

In addition, it is assumed that the peak data consumption and input rates are 6.4 Mbps (the standard DTV broadcast rate) and that the receiver has 512 MBytes of main memory. Note that although a different set of disk parameters can lead to different absolute performance values, the relative performance between schemes remain the same.

Comparing κ-File Schemes with Non-Optimized

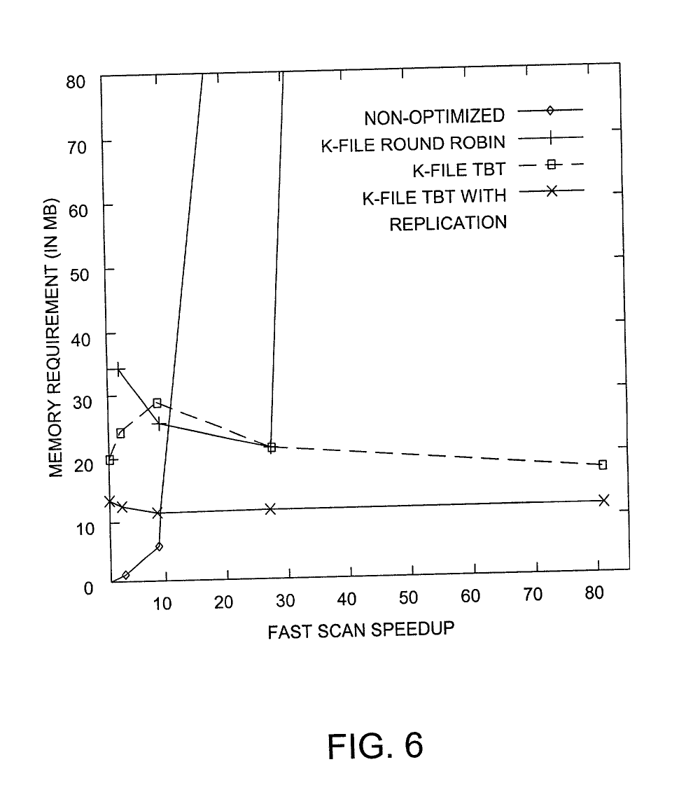

FIG. 6 compares the memory use of the various κ-file schemes with the non-optimized scheme (the scheme that stores a video in a sequential file). For this comparison, it is assumed that N=2, δ=9, Φ=3, and α=β=3. Although the comparison is performed with one set of values, the response of different schemes on varying the parameters remain similar. When K is large, the non optimized scheme simply runs out of disk bandwidth to support fast scans. This is because without maintaining high IO resolution, the disk bandwidth cannot keep up with the high speed fast scan operations. The κ-file Round Robin scheme uses much less main memory, but even this scheme starts suffering at high speedups. The κ-file TBT schemes maintain almost constant memory requirement for all speedups due to their good IO resolution.

Evaluating the κ-File Schemes

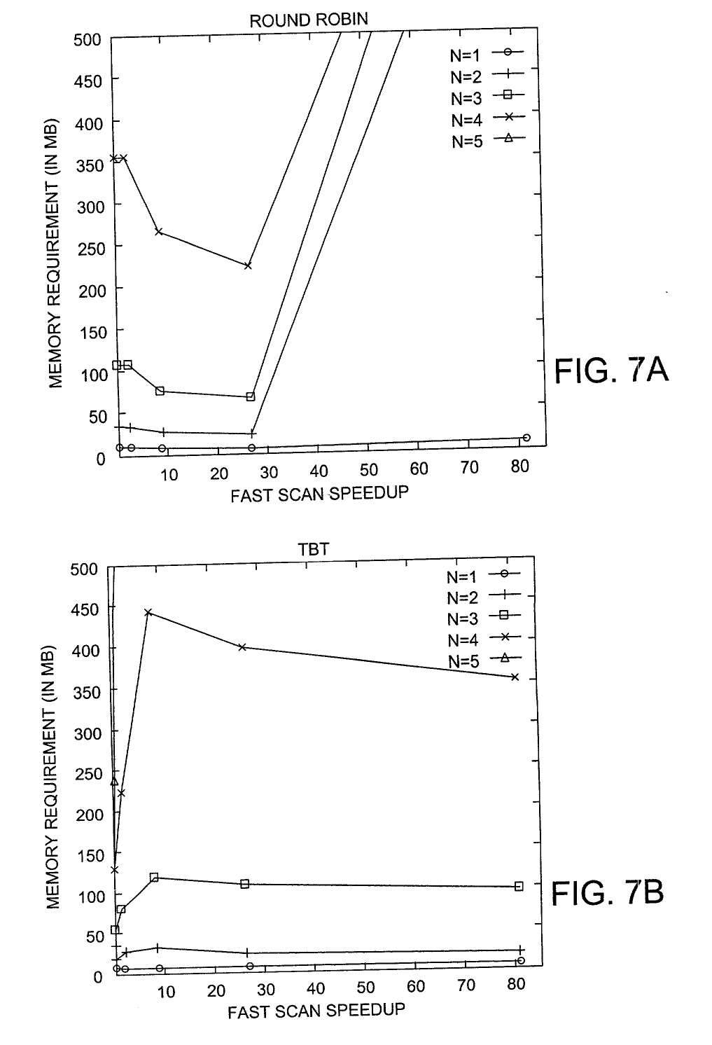

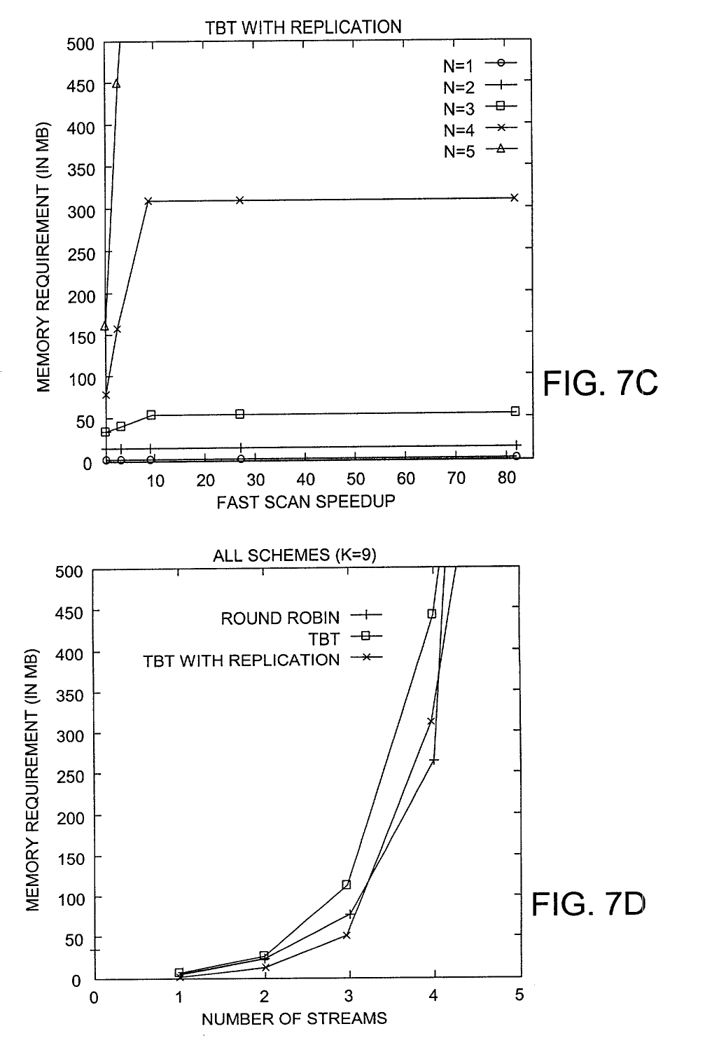

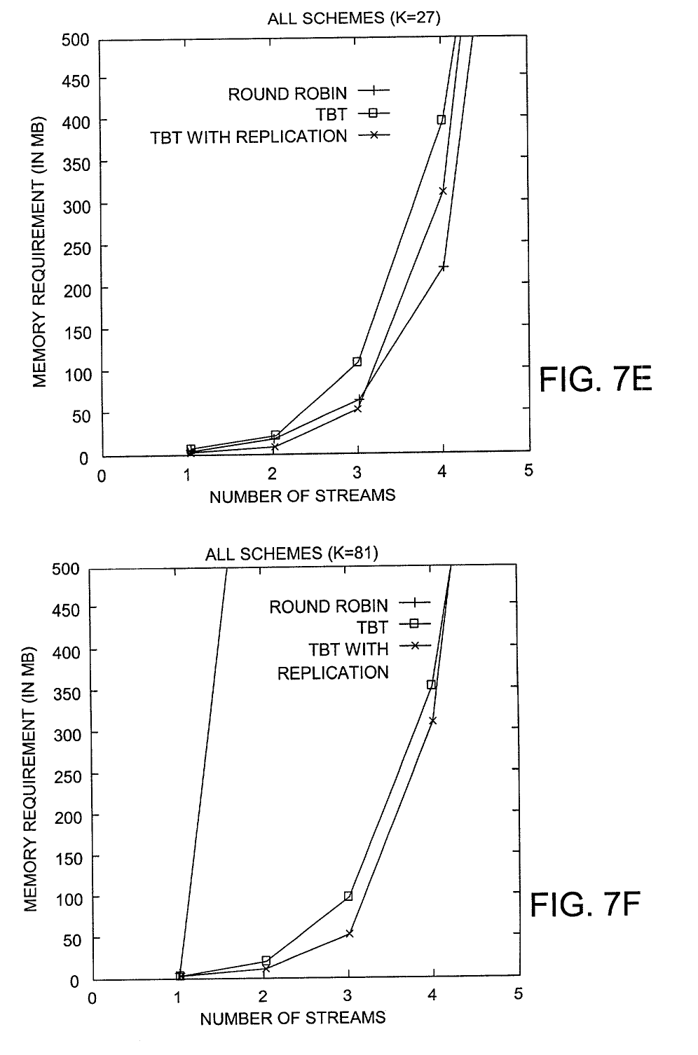

To evaluate the κ-file schemes, different N values may be used to determine how the κ-file schemes cope with simultaneous users at different fast scan speedups. FIGS. 7(a)-7(f) comprise various graphs that illustrate the relationship between the memory requirement and fast scan speedup for the various schemes and/or K values.

FIG. 7(a) shows that the Round Robin scheme can support low speedup fast scans with low memory use for up to N=3. But, the scheme needs more amounts of main memory to support K=81 even for two simultaneous users (N=2), and it simply may not be capable of supporting more than one stream doing K fast scans simultaneously. Additionally, it may be noted that the memory requirement for supporting K=9 and 27 is less than that for supporting K1 and 3. This discrepancy occurs because, to support K=9,27 times speedups, the PB-file does not need to be accessed and hence seek overhead is reduced. Furthermore, for K=27, only one I-file needs to be read and the IO resolution is 100%. Thus, this scheme may be used to reduce seek overhead. However, IO resolution may suffer at K>27 scan speeds. This suggests that the Round Robin scheme may only be good for lower scan speeds.

FIG. 7(b) shows that the κ-file TBT approach without data replication scheme is able to support up to four simultaneous streams each performing K=81 times fast scan. For small values of K, however, the TBT scheme suffers from high memory use due to the large number of seeks caused by the large number of I-files it must read. This result suggests that the TBT scheme is more suitable for supporting high speedup fast scans.

FIG. 7(c) shows that the TBT scheme with data replication is able to support up to four simultaneous streams scanning at speeds of up to K=81. This scheme maintains constant memory use for all scan speedups. Another thing to be noted is that for small values of N (N=1, N=2), the normal playback mode (K=1) requires more memory than for fast scans. This is because for small N, the extra seek to the PB-File involved in normal playback dominates the data transfer overhead for fast scans. Although the replication scheme requires additional storage, it may conserve memory as well as improves disk utilization because of its better IO resolution.

FIGS. 7(d)-7(f) compares the memory requirement for the three κ-file schemes side by side at three speedups. FIG. 7(d) shows that the Round Robin scheme is able to support up to four streams at K=9 speedup, but not beyond due to huge memory requirement. Also for lower speedups the Round Robin scheme may outperform the TBT non replicated scheme. But as N increases, the IO resolution scalability of the TBT schemes kicks in and both TBT schemes outperform the Round Robin scheme.

FIG. 7(e) shows that for K=27, the Round Robin scheme may perform better or at least as good as the TBT schemes. This is because at K=27, the IO resolution of the Round Robin scheme is 100% and the seek latency is minimum. But, for K=81 in FIG. 7(f) the Round Robin scheme is not able to keep up with the performance of the TBT schemes owing to degradation in IO resolution.

Storage Optimization

To answer the storage optimization question, the total cost of a system implemented using the TBT schemes and determine trade-offs may be evaluated. Embodiments of the invention may be used to support up to K=81 fast scan speedup (or greater). In computations, disk cost is assumed to be approximately one-hundredth of memory cost. The cost unit used is cost per GB of hard disk. The storage cost is directly proportional to the amount of buffer made available to the user for fast scan operations.

For example, providing the user with 30 minutes of rewind or forward buffer adds a storage overhead of

$$30 \times 60 \times 6.4 \times \frac{1}{ϕ}$$

megabits. The fraction

$$\frac{1}{ϕ}$$

is the fraction of data (composed of I frames) that needs to be replicated. The presence of distinct crossover points suggests the existence of a cost performance trade-off between the replicated and non-replicated TBT schemes.

As the number of streams increases, the memory requirement for both the schemes increases. Although the disk storage cost for the TBT scheme also increases, it Increases at a lower rate than the memory cost. Thus the difference between the cost of the TBT scheme with replication and the cost of the TBT scheme reduces as the number of streams (N) increases. The point at which these costs are equal is the crossover point. For 30 minutes of disk buffering, the crossover point occurs a little above one simultaneous user. This suggests that if a single user needs to be supported in the system, then the TBT scheme is optimal due to higher disk cost involved in the TBT scheme with replication. But if more than one user needs to be supported, the TBT scheme with replication more than makes up for the additional storage overhead by providing excellent IO resolution. But for two hours of buffering, the non-replicated scheme is good for up to three simultaneous users. But since the cost difference between the TBT schemes is not much and given the fact that absolute cost of additional disk storage is relatively small, replication becomes an attractive option.

In addition, if it is assumed that MemoryCost>100×DiskCost, then the crossover point moves down in the curves, suggesting that the

$$\frac{cost}{benefit}$$

ratio of the TBT scheme with extra storage decreases. Further, if it is assumed that MemoryCost<100×DiskCost, then the

$$\frac{cost}{benefit}$$

ratio of the TBT scheme with extra storage increases, and the crossover point moves further up in the curves.

In short, given system requirements and the cost ratios for memory and disk, it may be determined if replication is beneficial.

Experimental Observations

From the experimental results various observations may be made. For example, using the naive sequential placement policy incurs huge memory requirements and hence is not desirable. For low speedup (K≦κ×δ) fast-scans, the IO resolution provided by the Round Robin scheme proves sufficient and performs well using a reasonable amount of memory.

For high speedup (K>κ×δ) fast-scans, the Round Robin scheme suffers from poor IO resolution. The TBT schemes enjoy good IO resolution and hence are able to perform better than the Round Robin scheme given the same amount of memory. For supporting a large number of users (N>4), the TBT scheme with replication may be the choice.

Additionally, if the cost difference of the TBT schemes is small, replication may become an attractive option given the fact that absolute cost of additional disk storage is small.

With a different set of disk parameters, the absolute performance numbers described above and in the figures may be different. However, the magnitude of difference is insignificant. Most importantly, the experimental results show that intelligent data placement significantly improves a digital VCR's throughput and its quality of service.

Admission Control

Various data placement policies may be utilized to improve system performance. However, a systematic procedure for choosing the best scheme to employ in a given situation would be useful. In addition, if a requested speedup cannot be serviced by the available system resources, it may be desirable to perform a graceful degradation to still satisfy the user's need to a certain degree. An admission control policy in accordance with the invention may achieve these goals.

Suppose the placement policy is given by P where P∈{‘Round Robin’, ‘TBT’, ‘TBT with Replication’}. Let M_{free} denote the Free system memory and M(K) denote the extra memory required to support a K speedup fast scan stream. Also, let Mₘᵢₙ denote the minimum memory requited to support fast scan at the lowest possible speed.

The admission control policy is depicted in the pseudocode of TABLE 4.

TABLE 4
Procedure: Admission
Variables:

κ, α, β

Input:

P: Placement Policy
Kᵢₙ: requested Speed of fast-scan

Output:

allow: Boolean, denoting whether the stream should be admitted
Kₒᵤₜ: Speed at which fast-scan stream will be served

Execution:

If (M_{free} < Mₘᵢₙ)

allow = false

Else Switch &Ovalhollow; {

1. Case (M (Kᵢₙ) < M_{free}):

| | |
|---|---|
| 1.1 | Allow = true |
| 1.2 | Kₒᵤₜ = Kᵢₙ |

2. Case (P = ‘Round Robin’):

| | |
|---|---|
| 2.1 | ${K}_{in } = \frac{{K}_{in}}{κ}$ |
| 2.2 | If (M_{free} < M (Kᵢₙ)) goto Step 2.1 |
| 2.3 | allow = true |
| 2.4 | Kₒᵤₜ = Kᵢₙ |

3. Case (P = = ‘TBT’ or ‘TBT without repiciation’):

| 3.1 | ${K}_{in } = \frac{{K}_{in}}{β}$ |
|---|---|
| 3.2 | If (M_{free} < M(Kᵢₙ) and Kᵢₙ ≧ α) goto Step 3.1 |
| 3.3 | If (M_{free} < M(Kᵢₙ) and P = ‘TBT’) |
| | 3.3.1 allow = true |
| | 3.3.2 Use method ‘Degrade-TBT’ |
| 3.4 | Else |

3.4.1 allow = true
3.4.2 Kₒᵤₜ = Kᵢₙ

If the free system memory cannot serve the lowest possible quality of fast scan using Mₘᵢₙ amount of memory (i.e., M_{free}<Mₘᵢₙ), the stream is not served and the program exits. Similarly, if this is not true (i.e., M_{free}≦Mₘᵢₙ), it is known that the request will at least be served. If enough resources are available to serve the request (i.e., M (Kᵢₙ) <M_{free}), the request is served.

Otherwise, the method used to degrade service depends on the policy. If the policy is Round Robin, then the scan speed is reduced by a factor of κ until the available system memory is able to support it. If the policy is TBT with replication or TBT, then the scan speed is reduced by a factor β until the request may be served with free memory. Additionally, if the scheme is TBT, if the above method is not able to serve the request a method ‘Degrade-TBT’ is used to serve the request.

The degrade-TBT method provides that the requested scan speed is K=α×βⁱ⁻¹×δ. I frames are then read from file F₁ only and all frames read are displayed. The fraction of frames dropped is approximately equal to

$$\frac{1}{β} .$$

Accordingly, although there is degradation of quality, the request is served.

Note that it is easy to modify the admission control policy to support different objective functions which in turn dictate QoS in the system. For instance, if the objective is to maximize the number of simultaneous users in the system, then the fast scan speeds may be degraded for the users accordingly. If the objective is to provide the best service to existing users, then less number of new users should be admitted. If the objective is to take both into consideration then the objective function, F, can be expressed as a function of K and N:

$$F ( K , N ) = \frac{B ( K , N )}{C ( K , N )}$$

B(K,N) is the benefit obtained by serving N streams and a combined fast scan speed of K, for all streams. C(K,N) is the cost (memory+disk) for serving the N streams. Custom values can be obtained for B(K,N) depending on consumer behavior. The admission control policy can be easily modified to match the requirement of such a system.

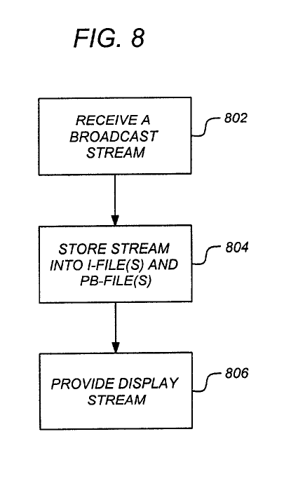

FIG. 8 is a flow chart illustrating the support of multiple interactive digital video streams in accordance with one or more embodiments of the invention. At step 802, a broadcast digital video stream is received. At step 804, the broadcast stream is stored into one or more I-files comprised of one or more I frames and one or more PB-files. Each PB-file is comprised of one or more P frames and/or B frames. At step 806, a display stream is provided that is based on the one or more I-files. Using the I-files (and one or more of the frames in each I-file), multiple streams may be supported.

As described above, the broadcast stream may be stored into a receiving buffer and stored in the I-files and PB-files when the receiving buffer is full. Further, to provide one or more display streams, each display stream may be stored/placed into a different display buffer and/or displayed to a viewer 110.

Additionally, step 804 may be performed using one of the data placement policies described above. Accordingly, the I frames may be distributed into one or more I-files in a round-robin manner, a truncated binary tree manner, or a truncated binary tree with data replication manner. Further, the appropriate policy may be used based on available system memory and other factors.

Conclusion

This concludes the description of the preferred embodiment of the invention. The following describes some alternative embodiments for accomplishing the present invention. For example, any type of computer, such as a mainframe, minicomputer, or personal computer, or computer configuration, such as a timesharing mainframe, local area network, or standalone personal computer, could be used with the present invention.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A method for supporting multiple interactive digital video streams comprising:
receiving a first broadcast digital video stream;
storing the first broadcast digital video stream into one or more I-files comprised of one or more intraframes (I-frames) and one or more PB-files comprised of one or more frames selected from a group comprising a predicted frame (P-frame) and a bi-directional predicted frame 3-frame); and
providing a first display digital video stream based on the one or more I-files.

2. The method of claim 1 wherein the first display digital video stream is provided further based on the one or more PB-files.

3. The method of claim 1 wherein I-frames within an I-file are skipped to support a fast scan.

4. The method of claim 1 further comprising storing the first broadcast digital video stream into a receiving buffer for the first broadcast digital video stream.

5. The method of claim 4 wherein the first broadcast digital video stream is stored in the one or more I-files and one or more PB-files when the receiving buffer is full.

6. The method of claim 1 wherein providing comprises storing the first display digital video stream in a display buffer.

7. The method of claim 1 further comprising causing the first display digital video stream to be displayed to a viewer.

8. The method of claim 1 further comprising providing a second display digital video stream based on the one or more I-files.

9. The method of claim 8 wherein:
the first display digital video stream is stored in a first display buffer; and
the second display digital video stream is stored ill a second display buffer that is different than the first display buffer.

10. The method of claim 1 wherein the first display digital video stream complies with a motion picture experts group (MPEG) standard.

11. The method of claim 1 further comprising allocating a set of memory pages for receiving the first broadcast digital video stream, wherein:
the first broadcast digital video stream is stored from one of the memory pages into the one or more I-files and one or more PB-files when one of the memory pages is full; and
the first display digital video stream is provided pursuant to reading data stored in the one or more I-files when a decoder has consumed one of the memory pages.

12. The method of claim 11 wherein the set of memory pages comprises four (4) memory pages.

13. The method of claim 1 wherein if free system memory is less than a minimum memory required to support a requested speedup fast-scan stream, the requested fast-scan stream is not provided as the first display digital video stream.

14. The method of claim 1 wherein if free system memory is greater than a minimum memory required to support a requested speedup fast-scan stream, the requested fast-scan stream is provided as the first display digital video stream.

15. The method of claim 1 wherein the one or more I-frames are distributed into one or more I-files in a round-robin manner.

16. The method of claim 15 wherein one or more I-frames numbered as I₁, I₂, I₃. . . Iₘare placed among κ I-files F₁, F₂, . . . Fκ, in die following round-robin manner:
$${F}_{i} = \{ {I}_{i + n \times κ} \vert n = 1 , 2 , 3 ⋯ \frac{m}{κ} \} .$$

17. The method of claim 15 further comprising:
determining if free system memory is less than a minimum memory required to support a requested speedup fast-scan stream;
if free system memory is not less than the minimum memory required to support the requested speedup fast-scan stream, providing the requested speedup fast-scan stream as the first display digital video stream; and
if free system memory is less than the minimum memory required to support a requested speedup fast-scan stream, reducing the requested scan speed until available system memory is able to support the reduced scan speed and providing the reduced scan speed stream as the first display digital video stream.

18. The method of claim 1 wherein the one or more I-frames ate organized into a tree-structure and each level of the tree structure is represented by one or more I-files.

19. The method of claim 18 wherein each level of the tree-structure represents a fast-scan speed for the first display digital video stream that is provided.

20. The method of claim 18 further comprising:
(a) if free system memory is not less than a minimum memory required to support a requested speedup fast-scan stream, providing the requested speedup fast-scan stream as the first display digital video stream;
(b) if free system memory is less than a minimum memory required to support the requested speedup fast-scan stream and the requested speedup fast-scan is greater than or equal to a frame span factor:
(i) reducing the requested scan speed until available system memory is able to support the reduced scan speed and the reduced speedup fast-scan is greater than or equal to the frame span factor; and
(ii) providing the reduced scan speed stream as the first display digital video stream.

21. The method of claim 20 wherein if reducing the scan speed does not result in the ability for available system memory to support the reduced scan speed or a reduced speedup fast-scan that is greater than or equal to the frame span factor, then the first display digital video stream is provided by:
setting the scan-speed K to α×βⁱ⁻¹×δ, wherein α is a frame span factor, β is a scan speed resolution factor, and δ is an average number of frames in a frame sequence;
reading I-frames from an I-file; and
providing all I-frames read in the first display digital video stream, wherein a fraction of I-frames dropped are approximately equal to
$$\frac{1}{β} .$$

22. The method of claim 18 wherein an in-order traversal of the tree-structure is used to support normal playback for the first display digital video stream.

23. The method of claim 18 wherein the I-frames are distributed among κ I-files F₁, F₂, . . . F_{κ}, in the following manner:
F₁={I_{κ}|1≦κ≦m∩I_{κ}∉{F₂∪F₃∪F₄. . . ∪F_{κ}}} such that
Fᵢ={I_{n×α×β}_{ⁱ⁻¹}|n∈{1,2,3, . . . }∩I_{n×α×β}_{ⁱ⁻¹}∉{Fᵢ₊₁∪Fᵢ₊₂∪Fᵢ₊₃. . . ∪F_{κ}}}, for 2≦i≦κ
wherein α is a frame span factor, β is a scan speed resolution factor, and m is a number of frame sequences in the first broadcast digital video stream.

24. The method of claim 18 wherein the I-frames ate distributed among κ I-files F₁, F₂, F_{κ}, in the following manner:
Fᵢ={I_{κ}|1≦κ≦m} such that
Fᵢ={I_{n×α×β}_{ⁱ⁻¹}|n∈{1,2,3, . . . }}, for 2≦i≦κ
wherein α is a frame span factor, β is a scan speed resolution factor, and m is a number of frame sequences in the first broadcast digital video stream.

25. A system for supporting multiple interactive digital video streams comprising:
(a) a receiver configured to:
(i) receive a first broadcast digital video stream; and
(ii) store the first broadcast digital video stream into one or more I-files comprised of one or more intraframes (I-frames) and one or more PB-files comprised of one or more frames selected from a group comprising a predicted frame (P-frame) and a bi-directional predicted frame (B-frame); and
(b) a scheduler configured to provide a first display digital video stream based on the one or more I-files.

26. The system of claim 25 wherein the first display digital video stream is further based on the one or more PB-files.

27. The system of claim 25 wherein I-frames within an I-file are skipped to support a fast scan.

28. The system of claim 25, wherein the receiver is further configured to store the first broadcast digital video stream into a receiving buffer for the first broadcast digital video stream.

29. The system of claim 28 wherein the receiver stores the first broadcast digital video stream in the one or more I-files and one or more PB-files when the receiving buffer is full.

30. The system of claim 25 wherein the scheduler is configured to provide the first display digital video stream by storing the first display digital video stream in a display buffer.

31. The system of claim 25 further comprising a display thread that displays the first display digital video stream to a viewer.

32. The system of claim 25 wherein the scheduler is further configured to provide a second display digital video stream based on the one or more I-files.

33. The system of claim 32 wherein the scheduler:
stores the first display digital video stream in a first display buffer; and
stores the second display digital video stream in a second display buffer that is different than the first display buffer.

34. The system of claim 25 wherein the first display digital video stream complies with a motion picture experts group (MPEG) standard.

35. The system of claim 25 further comprising a resource manager configured to allocate a set of memory pages for receiving the first broadcast digital video stream, wherein:
the receiver is configured to store the first broadcast digital video stream from one of the memory pages into the one or more I-files and one or more PB-files when one of the memory pages is full; and
the scheduler is configured to provide the first display digital video stream pursuant to reading data stored in the one or more I-files when a decoder has consumed one of the memory pages.

36. The system of claim 35 wherein the set of memory pages comprises four (4) memory pages.

37. The system of claim 25 wherein if free system memory is less than a minimum memory required to support a requested speedup fast-scan stream, the scheduler does not provide the requested fast-scan stream as the first display digital video stream.

38. The system of claim 25 wherein if free system memory is greater than a minimum memory required to support a requested speedup fast-scan stream, the scheduler provides the requested fast-scan stream as the first display digital video stream.

39. The system of claim 25 wherein the receiver stores the one or more I-frames into one or more I-files in a round-robin manner.

40. The system of claim 39 wherein one or more I-frames numbered as I₁, I₂, I₃. . . Iₘ are stored among κI-files F₁, F₂, . . . F_{κ}, in the following round-robin manner:
$${F}_{i} = \{ {I}_{i + n \times κ} \vert n = 1 , 2 , 3 ⃛ \frac{m}{κ} \} .$$

41. The system of claim 39 wherein the scheduler is further configured to:
determine if free system memory is less than a minimum memory required to support a requested speedup fast-scan stream;
if free system memory is not less than the minimum memory required to support the requested speedup fast-scan stream, provide the requested speedup fast-scan stream as the first display digital video stream; and
if free system memory is less than the minimum memory required to support a requested speedup fast-scan stream, reduce the requested scan speed until available system memory is able to support the reduced scan speed and provide the reduced scan speed stream as the first display digital video stream.

42. The system of claim 25 wherein the receiver is further configured to organize the one or more I-frames into a tree-structure and each level of the tree structure is represented by one or more I-files.

43. The system of claim 42 wherein each level of the tree-structure represents a fast-scan speed for the first display digital video stream that is provided.

44. The system of claim 42, wherein the scheduler is further configured to:
(a) provide the requested speedup fast-scan stream as the first display digital video stream if free system memory is not less than a minimum memory required to support a requested speedup fast-scan stream;
(b) if free system memory is less than a minimum memory required to support the requested speedup fast-scan stream and the requested speedup fast-scan is greater than or equal to a frame span factor:
(i) reduce the requested scan speed until available system memory is able to support the reduced scan speed and the reduced speedup fast-scan is greater than or equal to the frame span factor; and
(ii) provide the reduced scan speed stream as the first display digital video stream.

45. The system of claim 44 wherein if reducing the scan speed does not result in the ability for available system memory to support the reduced scan speed or a reduced speedup fast-scan that is greater than or equal to the frame span factor, then the scheduler provides the first display digital video stream by:
setting the scan-speed K to α×βⁱ⁻¹×δ, wherein α is a frame span factor, β is a scan speed resolution factor, and δ is an average number of frames in a frame sequence;
reading I-frames from an I-file; and
providing all I-frames read in the first display digital video stream, wherein a fraction of I-frames dropped are approximately equal to
$$\frac{1}{β} .$$

46. The system of claim 42 wherein the scheduler performs an in-order traversal of the tree-structure to support normal playback for the first display digital video stream.

47. The system of claim 42 wherein the receiver stores the I-frames among κ I-files F₁, F₂, . . . F κ, in the following manner:
F₁={I_{κ}|1≦κ≦m∩I_{κ}∉{F₂∪F₂∪F₃. . . ∪F₄. . . F_{κ}}} such that
Fᵢ={I_{n×α×β}_{ⁱ⁻¹}|n∈{1,2,3, . . . }∩I_{n×α×β}_{ⁱ⁻¹}∉{Fᵢ₊₁∪Fᵢ₊₂∪Fᵢ₊₃. . . ∪F_{κ}}}, for 2≦i≦κ
wherein α is a frame span factor, β is a scan speed resolution factor, and m is a number of frame sequences in the first broadcast digital video stream.

48. The system of claim 42 wherein the receiver stores the I-frames among κ I-files F₁, F₂, . . . Fκ, in the following manner:
Fᵢ={I_{κ}|1≦κ≦m} such that
Fᵢ={I_{n×α×β}_{ⁱ⁻¹}|n∈{1,2,3, . . . }}, for 2≦i≦κ
wherein α is a frame span factor, β is a scan speed resolution factor, and m is a number of frame sequences in the first broadcast digital video stream.

49. An article of manufacture comprising a program storage medium readable by a computer hardware device and embodying one or more instructions executable by the computer hardware device to perform a method for supporting multiple interactive digital video streams, the method comprising:
receiving a first broadcast digital video stream;
storing the first broadcast digital video stream into one or more I-files comprised of one or more intraframes (I-frames) and one or more PB-files comprised of one or more frames selected from a group comprising a predicted frame (P-frame) and a bi-directional predicted frame (B-frame); and
providing a first display digital video stream based on the one or more I-files.

50. The article of manufacture of claim 49 wherein the first display digital video stream is provided further based on the one or more PB-files.

51. The article of manufacture of claim 49 wherein I-frames within an I-file are skipped to support a fast scan.

52. The article of manufacture of claim 49, the method further comprising storing the first broadcast digital video stream into a receiving buffer for the first broadcast digital video stream.

53. The article of manufacture of claim 52 wherein the first broadcast digital video stream is stored in the one or more I-files and one or more PB-files when the receiving buffer is full.

54. The article of manufacture of claim 49 wherein providing comprises storing the first display digital video stream in a display buffer.

55. The article of manufacture of claim 49, the method further comprising causing the first display digital video stream to be displayed to a viewer.

56. The article of manufacture of claim 49, the method further comprising providing a second display digital video stream based on the one or more I-files.

57. The article of manufacture of claim 56 wherein:
the first display digital video stream is stored in a first display buffer; and
the second display digital video stream is stored in a second display buffer that is different than the first display buffer.

58. The article of manufacture of claim 49 wherein the first d display digital video stream complies with a motion picture experts group (MNPEG) standard.

59. The article of manufacture of claim 49, the method further comprising allocating a set of memory pages for receiving the first broadcast digital video stream, wherein:
the first broadcast digital video stream is stored from one of the memory pages into the one or more I-files and one or more PB-files when one of the memory pages is full; and
the first display digital video stream is provided pursuant to reading data stored in the one or more I-files when a decoder has consumed one of the memory pages.

60. The article of manufacture of claim 59 wherein the set of memory pages comprises four (4) memory pages.

61. The article of manufacture of claim 49 wherein if free system memory is less than a minimum memory required to support a requested speedup fast-scan stream, the requested fast-scan stream is not provided as the first display digital video stream.

62. The article of manufacture of claim 49 wherein if free system memory is greater than a minimum memory required to support a requested speedup fast-scan stream, the requested fast-scan stream is provided as the first display digital video stream.

63. The article of manufacture of claim 49 wherein the one or more I-frames are distributed into one or more I-files in a round-robin manner.

64. The article of manufacture of claim 63 wherein one or more I-frames numbered as I₁, I₂, I₃. . . Iₘ are placed among κ I-files F₁, F₂, . . . Fκ, in the following round-robin manner:
$${F}_{i} = \{ {I}_{i + n \times κ} \vert n = 1 , 2 , 3 ⃛ \frac{m}{κ} \} .$$

65. The article of manufacture of claim 63, the method further comprising:
determining if free system memory is less than a minimum memory required to support a requested speedup fast-scan stream;
if free system memory is not less than the minimum memory required to support the requested speedup fast-scan stream, providing the requested speedup fast-scan stream as the first display digital video stream; and
if free system memory is less than the minimum memory required to support a requested speedup fast-scan stream, reducing the requested scan speed until available system memory is able to support the reduced scan speed and providing the reduced scan speed stream as the first display digital video stream.

66. The article of manufacture of claim 49 wherein the one or more I-frames ate organized into a tree-structure and each level of the tree structure is represented by one or more I-files.

67. The article of manufacture of claim 66 wherein each level of the tree-structure represents a fast-scan speed for the first display digital video stream that is provided.

68. The article of manufacture of claim 66, the method further comprising:
(a) if free system memory is not less than a minimum memory required to support a requested speedup fast-scan stream, providing the requested speedup fast-scan stream as the first display digital video stream;
(b) if free system memory is less than a minimum memory required to support the requested speedup fast-scan stream and the requested speedup fast-scan is greater than or equal to a frame span factor:
(i) reducing the requested scan speed until available system memory is able to support the reduced scan speed and the reduced speedup fast-scan is greater than or equal to the frame span factor; and
(ii) providing the reduced scan speed stream as the first display digital video stream.

69. The article of manufacture of claim 68 wherein if reducing the scan speed does not result in the ability for available system memory to support the reduced scan speed or a reduced speedup fast-scan that is greater than or equal to the frame span factor, then the first display digital video stream is provided by:
setting the scan-speed K to α×βⁱ⁻¹×δ, wherein α is a frame span factor, β is a scan speed resolution factor, and δ is an average number of frames in a frame sequence;
reading I-frames from an I-file; and
providing all I-frames read in the first display digital video stream, wherein a fraction of I-frames dropped are approximately equal to
$$\frac{1}{β} .$$

70. The article of manufacture of claim 66 wherein an in-order traversal of the tree-structure is used to support normal playback for the first display digital video stream.

71. The article of manufacture of claim 66 wherein the I-frames are distributed among κ I-files F₁, F₂, . . . Fκ, in the following manner:
F₁={I_{κ}|1≦κ≦m∩I_{κ}∉{F₂∪F₃∪F₄. . . ∪F_{κ}}} such that
Fᵢ={I_{n×α×β}_{ⁱ⁻¹}|n∈{1,2,3, . . . }∩I_{n×α×β}_{ⁱ⁻¹}∉{Fᵢ₊₁∪Fᵢ₊₂∪Fᵢ₊₃. . . ∪F_{η}}}, for 2≦i≦κ
wherein α is a frame span factor, β is a scan speed resolution factor, and m is a number of frame sequences in the first broadcast digital video stream.

72. The article of manufacture of claim 66 wherein the I-frames are distributed among κ I-files F₁, F₂, . . . Fκ, in the following manner:
Fᵢ={I_{κ}|1≦κ≦m} such that
Fᵢ{I_{n×α×β}_{ⁱ⁻¹}|n∈{1,2,3, . . . }}, for 2≦i≦κ
wherein α is a frame span factor, β is a scan speed resolution factor, and m is a number of frame sequences in the first broadcast digital video stream.
